(19) United States
(12) Patent Application Publication
(10) Pub. No.: US 2010/0247866 A1
(43) Pub. Date: Sep. 30, 2010

(54) UNEVEN SURFACE FILM AND LIGHT DIFFUSIVE SHEET

(76) Inventors: Koji Nakahata, Saitama (JP); Shingo Ohsaku, Saitama (JP)

Correspondence Address: KENEALY VAIDYA LLP, 515 EAST BRADDOCK RD SUITE B, Alexandria, VA, 22314, US

(21) Appl. No.: 12/675,773

(22) PCT Filed: Sep. 11, 2008
(86) PCT No.: PCT/JP2008/066418

§ 371 Date: Feb. 26, 2010

(30) Foreign Application Priority Data
Sep. 27, 2007 (JP) 2007-251008
Sep. 27, 2007 (JP) 2007-251009

(51) Int. Cl. B32B 3/00

(52) U.S. Cl. 428/156

(57) ABSTRACT

An uneven surface film and a light-diffusing sheet are provided, which can prevent generation of scratches on surfaces thereof even when a plurality of the films or sheets are piled up or the film or sheet is superimposed on another member. The uneven surface film of the present invention has an uneven profile on a surface of the film, wherein the uneven profile shows a maximum peak height (Rp) of 6.0 μm or higher and a number of peaks (RHSC) of 600 peaks/0.5 mm² or less in a roughness curve determined by three-dimensional surface profilometry. This uneven surface film can be suitably used as a component member of a backlight, a light-diffusing sheet, or the like, and exhibits anti-scratch function as well as favorable light-diffusing property.

### TECHNICAL FIELD

The present invention relates to an uneven surface film having a special uneven profile on a surface thereof, in particular, a light-diffusing sheet suitably used as a member constituting a backlight unit of a liquid crystal display or the like.

### BACKGROUND ART

So far, there have been developed uneven surface films that can exhibit desired functions with special uneven surface profiles, such as anti-Newton ring films, surface protection films, non-glare sheets, lens sheets, light control sheets and light-diffusing sheets.

For light-diffusing sheets, for example, performances including ability to vanish light diffusion pattern in a light guide panel, high brightness for the frontal direction, and so forth are required, and in order to form surface unevenness satisfying such requirements, improvements have been made by changing types and contents of binder resin and light-diffusing particles used for a light-diffusing layer.

However, since increase of brightness for the frontal direction obtainable by the aforementioned improvements is limited, a prism sheet that can improve brightness for the frontal direction is generally used by disposing it on the light-diffusing sheet in order to obtain both sufficient brightness for the frontal direction and light-diffusing property (Patent documents 1 and 2).

Patent document 1: Japanese Patent Unexamined Publication (KOKAI) No. 9-127314 (claims)
Patent document 2: Japanese Patent Unexamined Publication No. 9-197109 (claims)

### DISCLOSURE OF THE INVENTION

### Object to be Achieved by the Invention

However, when a light-diffusing sheet and a prism sheet are piled up as described above, scratches may be generated on the uneven surface of the light-diffusing sheet as a light projecting surface, and the surface of the prism sheet facing the uneven surface. Further, when a plurality of such light-diffusing sheets are piled up and transported, scratches may also be similarly generated on the uneven surface and a surface facing the uneven surface. If scratches are generated as described above, even few scratches may cause defects in liquid crystal displays of higher definition becoming common in these days. Therefore, there arises a problem that, when it is attempted to constitute a backlight of a liquid crystal display by using such a light-diffusing sheet, extremely careful handling thereof is required, which invites decrease of productivity.

The problem of scratches generated when films are piled up is not a problem concerning only light-diffusing sheets, but is a common problem for uneven surface films, such as the anti-Newton ring films, surface protection films, non-glare sheets, lens sheets, and light control sheets mentioned above. That is, plural sheets of these uneven surface films may be piled up at the time of storage, transportation, and so forth. In such a case, an uneven surface of one uneven surface film contacts with a surface of another uneven surface film on the side opposite to an uneven surface, and scratches may be generated on the uneven surface of the uneven surface film and the surface facing it.

Therefore, an object of the present invention is to provide an uneven surface film which can prevent generation of scratches on a film surface at the time of piling up a plurality of such uneven surface films or superimposing such an uneven surface film on another member.

Another object of the present invention is to provide a light-diffusing sheet which can prevent generation of scratches on an uneven surface of the light-diffusing sheet or a surface of a member facing the uneven surface during use of the light-diffusing sheet as a member constituting a backlight of a liquid crystal display or transportation of the light-diffusing sheet, with exhibiting light-diffusing performance.

### Means for Achieving the Object

The inventors of the present invention conducted various researches concerning the aforementioned objects, and as a result, found that scratches generated on an uneven surface of an uneven surface film or a surface of a member facing the uneven surface were generated by foreign matters such as dust particles existing between films. Then, they found that if a specific three-dimensional profile was used as an uneven profile of an uneven surface film as a measure against the foreign matters, generation of scratches on the film surfaces due to the presence of foreign matters could be prevented, and thus accomplished the present invention.

That is, the uneven surface film of the present invention is an uneven surface film having an uneven profile on a surface of the film, wherein the uneven profile shows a maximum peak height (Rp) of 6.0 μm or higher and a number of peaks (RHSC) of 600 peaks/0.5 mm² or less in a roughness curve determined by three-dimensional surface profilometry.

Further, the light-diffusing sheet of the present invention is a light-diffusing sheet comprising a light-diffusing layer having an uneven profile on a surface of the layer, wherein the uneven profile shows a maximum peak height (Rp) of 6.0 μm or higher and a number of peaks (RHSC) of 600 peaks/0.5 mm² or less in a roughness curve determined by three-dimensional surface profilometry.

The maximum peak height (Rp) in a roughness curve determined by three-dimensional surface profilometry of the uneven profile referred to in the present invention is a value calculated from a three-dimensional roughness curve obtained by performing plotting for an area of 0.5 mm length and 1 mm width with pitches of 2 μm for the length direction and 1 μm for the width direction according to the two-dimensional surface profilometry defined in JIS-B0601:1994, and integrating two-dimensional roughness curves for the length direction and width direction obtained by the plotting. Further, the number of peaks (RHSC) means a value found from a three-dimensional roughness curve obtained in a similar manner for an area of 0.5 mm length and 1 mm width.

### EFFECT OF THE INVENTION

The uneven surface film of the present invention can prevent generation of scratches on the film surface due to presence of foreign matters, since it has a specific three-dimensional shape as the surface profile. Further, the light-diffusing sheet of the present invention can prevent generation of scratches due to presence of foreign matters with securing light-diffusing performance, since the uneven surface of the light-diffusing layer has a specific three-dimensional shape.

### BEST MODE FOR CARRYING OUT THE INVENTION

First, the uneven surface film of the present invention will be explained.

Use of the uneven surface film of the present invention is not particularly limited, so long as it is a film having an uneven profile on the surface. Specifically, it may be an anti-Newton ring film, surface protection film, non-glare sheet, lens sheet, light control sheet, light-diffusing sheet, or the like.

The uneven surface film of the present invention may have a layer structure consisting of a single layer or two or more layers, and a specific uneven profile is formed on at least one surface of a layer constituting a surface of the film. The layer on which the uneven profile is formed will be henceforth referred to as uneven profile layer.

The uneven profile layer of the uneven surface film of the present invention has an uneven surface profile showing a maximum peak height (Rp) of 6.0 μm or higher and a number of peaks (RHSC) of 600 peaks/0.5 mm² or less in a roughness curve determined by three-dimensional surface profilometry. If the uneven profile of the uneven profile layer is such a specific three-dimensional profile, foreign matters such as dust particles adhering to the uneven profile layer surface stay in concaves of the uneven profile. Even if two or more sheets of the uneven surface film of the present invention in this state are piled up, or the uneven surface film of the present invention in this state is superimposed on another member, the foreign matters do not contact convexes of the uneven profile layer or a surface of a member facing the uneven profile layer. Therefore, according to the present invention, there is provided a remarkable effect that scratches are not generated on the surface of the uneven surface film of the present invention or a surface of a member facing it, even if foreign matters exist between the films. The foreign matters such as dust particles referred to in the present invention mean those having a size of about 20 μm or smaller.

The aforementioned maximum peak height (Rp) in a roughness curve determined by three-dimensional surface profilometry is more preferably 8.0 μm or higher, still more preferably 10.0 μm or higher, in view of further preventing generation of scratches by foreign matters. Further, it is preferably 30.0 μm or smaller as an upper limit, in view of preventing exfoliation of particles and deformation of convexes.

The number of peaks (RHSC) is more preferably 500 peaks/0.5 mm² or less, still more preferably 350 peaks/0.5 mm² or less, also in view of further preventing generation of scratches by foreign matters. As for the lower limit, it is preferably not lower than 150 peaks/0.5 mm².

As methods for forming the aforementioned uneven profile, there are a method of incorporating particles for forming uneven profile, a method of forming the uneven profile by a shape transfer technique, and so forth.

When the uneven profile is forming by the former method, the uneven profile layer is mainly constituted by a polymer resin and particles for forming the uneven profile. As the polymer resin, resins showing superior optical transparency can be used, and there can be used, for example, thermoplastic resins, thermosetting resins, ionizing radiation curable resins and so forth, such as polyester resins, acrylic resins, acrylic urethane resins, polyester acrylate resins, polyurethane acrylate resins, epoxy acrylate resins, urethane resins, epoxy resins, polycarbonate resins, cellulose resins, acetal resins, polyethylene resins, polystyrene resins, polyamide resins, polyimide resins, melamine resins, phenol resins, and silicone resins. Among these, acrylic resins showing superior light resistance and optical characteristics are preferably used.

As the particles for forming the uneven profile on the surface of the uneven profile layer, inorganic microparticles such as those of silica, clay, talc, calcium carbonate, calcium sulfate, barium sulfate, aluminum silicate, titanium oxide, synthetic zeolite, alumina, and smectite, as well as organic microparticles such as those of styrene resin, urethane resin, benzoguanamine resin, silicone resin, and acrylic resin can be used. Among these, organic microparticles are preferably used, since it is easy to obtain spherical particles and control the uneven profile to be a desired profile with organic microparticles. Not only a single kind of particles, but also two or more kinds of particles can also be used in combination.

Content ratio of the particles to that of the polymer resin cannot generally be defined, since it may vary depending on the mean particle size of the particles to be used or thickness of the uneven profile layer. However, for more easily obtaining an uneven profile which can prevent generation of scratches by foreign matters, the particles are preferably used in an amount of 70 to 220 parts by weight, more preferably 120 to 220 parts by weight, with respect to 100 parts by weight of the polymer resin.

Although shape of the particles is not particularly limited, they are preferably spherical particles for more easily obtaining the uneven profile of the present invention. Further, the particles preferably have a mean particle size of 1 to 30 μm from the same point of view. In particular, when the uneven surface film of the present invention is used as an anti-Newton ring film or a non-glare sheet, it is more preferably 5 to 10 μm, and when it is used as a light control sheet or a light-diffusing sheet, it is more preferably 10 to 30 μm.

To the uneven profile layer, besides the aforementioned polymer resin and particles for forming the uneven profile, there may be added additives such as photopolymerization initiators, photopolymerization enhancers, surfactants such as leveling agents and antifoams, anti-oxidants and ultraviolet absorbers, resins and particles other than those mentioned above.

When the uneven profile of the uneven surface film of the present invention is formed by a shape transfer technique, shape transfer techniques of the 2P (Photo-Polymer) method, the 2T (Thermal-Transformation) method, the embossing method, and so forth can be used. According to shape transfer techniques, the uneven profile of the present invention is formed on the uneven profile layer of the uneven surface film by shape transfer using a mold having an uneven profile complementary to the uneven profile of the present invention. In this case, the uneven profile layer need not contain the particles mentioned above, and the uneven profile layer may be constituted by only the polymer resin. Therefore, an uneven surface film of more superior optical transparency can be produced. When the uneven surface film of the present invention is used as a surface protection film or a lens sheet, it is preferably produced by a shape transfer technique without adding the particles.

Although the method of forming an uneven profile complementary to the uneven profile of the present invention on a mold is not particularly limited, it can be produced, for example, as follows. That is, concaves are formed on a plate according to a fine perforation processing technique using a cutting tool having a specific section at the tip with controlling the cutting depth, and this plate is used as a mold for molding (female mold). Alternatively, convexes of a specific shape are formed on a plate according to a fine laser processing technique, and this plate is used as a male mold to prepare a mold for molding (female mold).

Thickness of the uneven profile layer is preferably 7 to 40 μm in view of making it easier to obtain the uneven profile of the present invention, which can prevent generation of scratches by foreign matters. The thickness of the uneven profile layer means the thickness from the top of the highest convex of the uneven surface to the surface opposite to the uneven surface.

When the uneven surface film of the present invention consists of two or more layers, for example, when the uneven profile layer is separately provided on a support, any material may be used as the support without any particular limitation. As such a support, for example, transparent plastic films consisting of one kind of material or a mixture of two or more kinds of materials selected from polyester resins, acrylic resins, acrylic urethane resins, polyester acrylate resins, polyurethane acrylate resins, epoxy acrylate resins, urethane resins, epoxy resins, polycarbonate resins, cellulose resins, acetal resins, vinyl resins, polyethylene resins, polystyrene resins, polypropylene resins, polyamide resins, polyimide resins, melamine resins, phenol resins, silicone resins, fluorocarbon resins, cyclic polyolefin resins, and so forth can be used. Among these, a polyethylene terephthalate film subjected to a stretching process, especially a polyethylene terephthalate film subjected to a biaxial stretching process, is preferred, since such a film shows superior mechanical strength and dimensional stability. Further, in order to improve adhesion to the uneven profile layer, a support of which surface is subjected to a corona discharge treatment, or a support provided with an easy adhesion layer is also preferably used. Thickness of the support is usually preferably about 10 to 400 μm.

The surface of the uneven surface film of the present invention opposite to the uneven surface may be subjected to a fine matting treatment in order to prevent adhesion with other members, or may be subjected to an anti-reflection treatment in order to improve light transmittance. Furthermore, a back coat layer, an antistatic layer or an adhesive layer may be provided on it by such coating and drying methods as described below.

As for the method of laminating the uneven profile layer of the present invention on a support, the uneven profile layer can be formed by coating a coating solution for uneven profile layer prepared by dissolving or dispersing materials including the aforementioned polymer resin, particles for forming the uneven profile and so forth in a suitable solvent on a support by a known conventional method, for example, bar coating, blade coating, spin coating, roll coating, gravure coating, curtain flow coating, die coating, spray coating, screen printing, and so forth, and drying it.

Further, the uneven profile layer of the uneven surface film of the present invention is formed by a shape transfer technique such as the 2P method, the 2T method and the embossing method, an uneven surface film having an uneven profile layer on which an uneven profile is transferred can be obtained by, for example, filling the aforementioned polymer resin which constitutes the uneven profile layer and so forth in a mold having an uneven profile complementary to a desired uneven profile to transfer the uneven profile, then curing the polymer resin, and delaminating the cured resin from the mold. When a support is used, an uneven surface film comprising a support and an uneven profile layer provided on the support, on which an uneven profile is transferred, can be obtained by filling the polymer resin and so forth in a mold, superimposing the support on the polymer resin, then curing the polymer resin, and delaminating the cured resin from the mold.

The uneven surface film of the present invention obtained as described above is used as, for example, an anti-Newton ring film, surface protection film, non-glare sheet, lens sheet, light control sheet, light-diffusing sheet, or the like.

Further, as described above, by producing the uneven surface film of the present invention only with the polymer resin using a shape transfer technique, an uneven surface film having not only superior scratch-preventing property, but also superior optical transparency can be obtained. Therefore, an uneven surface film produced by such a method can be particularly preferably used as a surface protection film, for which two kinds of the performances mentioned above are particularly required, among the films described above.

The uneven surface film of the present invention explained above does not suffer from scratches, because of the special uneven surface thereof, even when a plurality of the uneven surface films are piled up, and therefore undue carefulness is not required for handling thereof at the time of storage, transportation etc. Further, even when the uneven surface film is used by superimposing it on another member, generation of scratches of the film surface can be similarly prevented, and therefore it does not show any bad influence on the desired performance provided by the uneven surface profile.

The light-diffusing sheet as an embodiment of the uneven surface film of the present invention will be explained below.

The light-diffusing sheet of the present invention comprises a light-diffusing layer having an uneven profile on a surface thereof, and it may consist of, for example, a support and the light-diffusing layer formed on the support, or may consist of the light-diffusing layer alone. The procedure for forming the uneven profile is the same as that for the uneven surface film described above.

The light-diffusing sheet of the present invention exhibits a marked advantage that even if foreign matters such as dust particles adhere to the uneven profile surface, they stay in concaves of the uneven profile surface, because the surface of the light-diffusing layer has a specific three-dimensional profile, and therefore even if a prism sheet or another light-diffusing sheet is superimposed on it, the light-diffusing layer and the member facing it do not suffer from generation of scratches, and in addition, the light-diffusing sheet of the present invention exhibit the effect of superior light-diffusing property.

When the light-diffusing sheet of the present invention comprises a support and the light-diffusing layer formed on the support, the support is not particularly limited, so long as a light-transmitting support is chosen, and the materials used as the support of the uneven surface film mentioned above can be used. Further, in order to improve adhesion to the light-diffusing layer, a support of which surface is subjected to a corona discharge treatment, or a support provided with an easy adhesion layer is also preferably used. Thickness of the support is usually preferably about 20 to 400 μm.

The light-diffusing layer of the present invention is constituted by a binder resin, light-diffusing particles, and so forth. As the binder resin, resins showing superior optical transparency can be used. Specifically, resins similar to the polymer resins constituting the uneven profile layer of the uneven surface film mentioned above can be used, and acrylic resins showing superior light resistance and optical characteristics are particularly preferably used.

As the light-diffusing particles, inorganic microparticles such as those of silica, clay, talc, calcium carbonate, calcium sulfate, barium sulfate, aluminum silicate, titanium oxide, synthetic zeolite, alumina, and smectite, as well as organic microparticles such as those of styrene resin, urethane resin, benzoguanamine resin, silicone resin, and acrylate resin can be used. Among these, organic microparticles are preferably used, and organic microparticles consisting of an acrylic resin are particularly preferably used, in view of improving the performance concerning brightness. Not only a single kind of light-diffusing particles, but also two or more kinds of light-diffusing particles can also be used in combination. By combining two or more kinds of light-diffusing particles, favorable light-diffusing property can be obtained.

Content ratio of the light-diffusing particles to that of the binder resin cannot generally be defined, since it may vary depending on the mean particle size of the light-diffusing particles to be used, or thickness of the light-diffusing layer. However, in view of obtaining the uneven profile of the present invention with maintaining good balance of the light-diffusing property and brightness, the light-diffusing particles are preferably used in an amount of 70 to 220 parts by weight, more preferably 120 to 220 parts by weight, still more preferably 140 to 220 parts by weight, with respect to 100 parts by weight of the binder resin. By using the light-diffusing particles at a content ratio of 140 parts by weight or more, brightness distribution in a light guide panel and diffusing panel can be made more uniform.

Although shape of the light-diffusing particles is not particularly limited, they are preferably spherical particles showing superior light-diffusing property. Further, the light-diffusing particles preferably have a mean particle size of 1 to 30 μm, more preferably 10 to 30 μm, in view of obtaining the uneven profile of the present invention with maintaining good balance of the light-diffusing property and brightness. When two or more kinds of the light-diffusing particles are used in combination as described above, for example, a combination of particles having a relatively large particle size such as about 5 to 30 μm and particles having a relatively small particle size such as about 1 to 5 μm provides still more favorable light-diffusing property.

To the light-diffusing layer, besides the aforementioned binder resin and light-diffusing particles, there may be added additives such as surfactants such as leveling agents and antifoams, anti-oxidants and ultraviolet absorbers, resins and particles other than those mentioned above.

Thickness of the light-diffusing layer is preferably 7 to 40 μm in view of making it easier to obtain the uneven profile of the present invention with securing the light-diffusing property.

The surface of the light-diffusing sheet of the present invention opposite to the uneven surface may be subjected to a fine matting treatment in order to prevent adhesion with other members in a backlight unit (light-guide panel etc.), or may be subjected to an anti-reflection treatment in order to improve light transmittance. Furthermore, a back coat layer or an antistatic layer having a thickness of about 5 μm or smaller may be provided on it by the methods described below.

The light-diffusing sheet of the present invention can be produced by coating a coating solution for light-diffusing layer prepared by dissolving or dispersing materials including the aforementioned binder resin, light-diffusing particles and so forth in a suitable solvent on a support by a known conventional method, for example, bar coating, blade coating, spin coating, roll coating, gravure coating, curtain flow coating, die coating, spray coating, screen printing, and so forth, and drying it.

The light-diffusing sheet of the present invention can also be produced by a shape transfer technique such as the 2P (Photo-Polymer) method, the 2T (Thermal-Transformation) method, or the embossing method. In this case, a light-diffusing sheet comprising a light-diffusing layer, on which an uneven profile is transferred, is produced by, for example, filling a binder resin which constitutes the aforementioned light-diffusing layer, and so forth in a mold having an uneven profile complementary to a desired uneven profile to transfer the uneven profile, then curing the binder resin, and delaminating the cured resin from the mold. When a support is used, a light-diffusing sheet comprising a support and a light-diffusing layer provided on the support, on which an uneven profile is transferred, can be obtained by filling a binder resin and so forth in a mold, superimposing the support on the binder resin, then curing the binder resin, and delaminating the cured resin from the mold. According to this method, the uneven profile is formed by the mold. Therefore, when it is desired to obtain favorable transparency, the light-diffusing particles may not be contained.

When the light-diffusing sheet of the present invention explained above is incorporated as one part of, mainly, a backlight unit constituting a light source of a liquid crystal display, an illumination signboard, a scanner or a copying machine, it is suitably used without suffering from generation of scratches on the uneven surface of the light-diffusing sheet or a member facing it, even if foreign matters are contained. Further, even if two or more of the light-diffusing sheets of the present invention are piled up and transported, the light-diffusing sheets are not scratched by foreign matters, and therefore undue carefulness is not required for handling thereof.

### EXAMPLES

Hereafter, the present invention will be further explained with reference to examples. The term “part” and symbol “%” are used in weight basis, unless especially indicated.

Further, in the following examples and comparative examples, a contact finger type surface profiler (SAS-2010 SAU-II, MEISHIN KOKI Co., Ltd., tip radius: 5 μm, material: diamond, measurement force: 0.8 mN) was used for the three-dimensional surface profilometry of uneven surfaces (uneven profiles). As the maximum peak heights (Rp) and numbers of peaks (RHSC) in a roughness curve determined by three-dimensional surface profilometry, averages of the values measured at arbitrary ten points are indicated.

### 1. Production of Uneven Surface Films (Surface Protection Films)

### Example 1

An uneven surface film (surface protection film) consisting of an uneven profile layer (thickness: 30 μm, 1800 mm×330 mm) was produced by using an injection molding machine under the conditions of cylinder temperature: 280° C. and mold temperature: 85° C. The uneven profile layer was formed from pellets of polycarbonate resin (Panlite L-1225, Teijin Chemicals Ltd.) as the polymer resin. As the mold, a mold a enabling shape transfer of a specific uneven profile formed by a fine perforating processing technique was used. The surface profile of the uneven profile layer of the surface protection film produced in Example 1 showed a maximum peak height (Rp) of 12.1 μm, and a number of peaks (RHSC) of 295 peaks/0.5 mm² in the roughness curve.

### Example 2

A surface protection film of Example 2 was produced in the same manner as that of Example 1, except that a mold b enabling shape transfer of a specific uneven profile formed by a fine perforating processing technique was used instead of the mold a used in Example 1. The three-dimensional surface profile of the uneven profile layer of the surface protection film produced in Example 2 showed a maximum peak height (Rp) of 10.3 μm, and a number of peaks (RHSC) of 331 peaks/0.5 mm² in the roughness curve.

### Example 3

A mold c enabling shape transfer of a specific uneven profile formed by a fine perforating processing technique was used. As a coating solution for uneven profile layer, a mixture of 50 parts of an acrylic monomer (methyl methacrylate, Wako Pure Chemical Industries Ltd.), 45 parts of a polyfunctional acrylic monomer (NK Ester A-TMPT-3EO, Shin-Nakamura Chemical Co., Ltd.), and 5 parts of a photopolymerization initiator (Irgacure 184, Chiba Specialty Chemicals Co., Ltd.) was filled in the mold c, and a polyethylene terephthalate film having a thickness of 100 μm (COSMOSHINE A4100, Toyobo Co., Ltd.), as a support, was adhered to it. Then, the uneven profile layer was cured by ultraviolet irradiation at 600 mJ/cm² with a high-pressure mercury vapor lamp, and the mold c was removed to produce a surface protection film of Example 3 comprising the support and the uneven profile layer having a thickness of 30 μm and formed on the support. The three-dimensional surface profile of the uneven profile layer of the surface protection film produced in Example 3 showed a maximum peak height (Rp) of 8.9 μm, and a number of peaks (RHSC) of 492 peaks/0.5 mm² in the roughness curve.

### Example 4

A surface protection film of Example 4 was produced in the same manner as that of Example 1, except that a mold d enabling shape transfer of a specific uneven profile formed by a fine perforating processing technique was used instead of the mold a used in Example 1. The three-dimensional surface profile of the uneven profile layer of the surface protection film produced in Example 4 showed a maximum peak height (Rp) of 6.2 μm, and a number of peaks (RHSC) of 592 peaks/0.5 mm² in the roughness curve.

### Example 5

Components of a coating solution for uneven profile layer of the following composition were mixed, and the mixture was stirred overnight, then applied to a support consisting of a polyethylene terephthalate film having a thickness of 50 μm (Lumirror T60, Toray Industries, Inc.) so as to obtain a dry thickness of 35 μm by the bar coating method, and dried to form an uneven profile layer and thereby produce a surface protection film of Example 5. The three-dimensional surface profile of the uneven profile layer of the surface protection film produced in Example 5 showed a maximum peak height (Rp) of 10.9 μm, and a number of peaks (RHSC) of 344 peaks/0.5 mm² in the roughness curve.

### <Coating Solution for Uneven Profile Layer of Example 5>

| | |
|---|---|
| Acryl polyol (ACRYDIC A-807, Dainippon Ink | 162 parts |
| & Chemicals, Inc., solid content: 50%) | |
| Isocyanate type curing agent (Takenate D110N, | 32 parts |
| Mitsui Chemicals Polyurethane, Inc., | |
| solid content: 60%) | |
| Acrylic resin particles (polymethyl | 210 parts |
| methacrylate resin particles, Techpolymer MBX-20, | |
| Sekisui Plastics Co., Ltd., | |
| mean particle size: 20 μm) | |
| Butyl acetate | 215 parts |
| Methyl ethyl ketone | 215 parts |

### Comparative Example 1

A surface protection film of Comparative Example 1 was produced in the same manner as that of Example 5, except that the coating solution for uneven profile layer of Example 5 was changed to a coating solution for uneven profile layer of the following composition, and the uneven profile layer was designed so as to have a dry thickness of 10 μm. The three-dimensional surface profile of the uneven profile layer of the surface protection film produced in Comparative Example 1 showed a maximum peak height (Rp) of 4.0 μm, and a number of peaks (RHSC) of 650 peaks/0.5 mm² in the roughness curve.

### <Coating Solution for Uneven Profile Layer of Comparative Example 1>

| | |
|---|---|
| Acryl polyol (ACRYDIC 49-394IM, Dainippon Ink | 50 parts |
| & Chemicals, Inc., solid content: 50%) | |
| Acryl polyol (ACRYDIC A-807, Dainippon Ink | 40 parts |
| & Chemicals, Inc., solid content: 50%) | |
| Isocyanate type curing agent (Takenate D110N, | 20 parts |
| Mitsui Chemicals Polyurethane, Inc., | |
| solid content: 60%) | |
| Acrylic resin particles (Techpolymer MBX-8, | 100 parts |
| Sekisui Plastics Co., Ltd., | |
| mean particle size: 8 μm) | |
| Butyl acetate | 200 parts |
| Methyl ethyl ketone | 200 parts |

### Comparative Example 2

A surface protection film of Comparative Example 2 was produced in the same manner as that of Example 1, except that a mold e enabling shape transfer of a specific uneven profile formed by a fine perforating processing technique was used instead of the mold a used in Example 1. The three-dimensional surface profile of the uneven profile layer of the surface protection film produced in Comparative Example 2 showed a maximum peak height (Rp) of 3.5 μm, and a number of peaks (RHSC) of 1104 peaks/0.5 mm² in the roughness curve.

### Comparative Example 3

A surface protection film of Comparative Example 3 was produced in the same manner as that of Example 1, except that a mold f enabling shape transfer of a specific uneven profile formed by a fine perforating processing technique was used instead of the mold a used in Example 1. The three-dimensional surface profile of the uneven profile layer of the surface protection film produced in Comparative Example 3 showed a maximum peak height (Rp) of 5.4 μm, and a number of peaks (RHSC) of 809 peaks/0.5 mm² in the roughness curve.

### 2. Evaluation

### (1) Anti-Scratch Property

One hundred sheets for each of the surface protection films of Examples 1 to 5 and Comparative Examples 1 to 3 were prepared, and piled-up 100 sheets for each of the surface protection films of the examples and comparative example were put into a polyethylene bag, the bag was placed between two sheets of cardboard, wrapped with a laminated paper sheet, and packaged in a corrugated box. Then, the corrugated box was transported from Mie to Tokyo by a truck (distance: about 600 km, average speed: 80 km/hour), then reciprocally transported once between Tokyo and Taiwan by an airplane (flight time: about 3 hours), and further transported from Tokyo to Mie by a track (the same distance as mentioned above). Thereafter, the uneven surfaces of the surface protection films of the examples and comparative examples and the smooth surfaces of the surface protection films having been facing the uneven surfaces were observed by visual inspection. The result that scratches on the surface were not conspicuous is indicated with the symbol “⊚”, the result that surface was slightly scratched, but scratches were substantially inconspicuous is indicated with the symbol “◯”, and the result that scratches were conspicuous is indicated with the symbol “x”. The test results are shown in Table 1.

TABLE 1

| | Maximum peak | Number of peaks | |
|---|---|---|---|
| | height (Rp) | (RHSC) | Anti-scratch |
| | [μm] | [peaks/0.5 mm²] | property |
| Example 1 | 12.1 | 295 | ⊚ |
| Example 2 | 10.3 | 331 | ⊚ |
| Example 3 | 8.9 | 492 | ◯ |
| Example 4 | 6.2 | 592 | ◯ |
| Example 5 | 10.9 | 344 | ⊚ |
| Comparative | 4 | 650 | X |
| Example 1 | | | |
| Comparative | 3.5 | 1104 | X |
| Example 2 | | | |
| Comparative | 5.4 | 809 | X |
| Example 3 | | | |

As shown in Table 1, in the surface protection films of Examples 1 to 5, the surface profiles of the uneven profile layers showed maximum peak heights (Rp) higher than 6.0 μm, and numbers of peaks (RHSC) smaller than 600 peaks/0.5 mm² in the roughness curves determined by three-dimensional surface profilometry, and, therefore, scratches on the uneven profile layer surfaces of the surface protection films and the surfaces having been facing them were substantially inconspicuous as observed by visual inspection. In particular, in the surface protection films of Examples 1 and 2, the surface profiles of the uneven profile layers showed maximum peak heights (Rp) higher than 10.0 μm, and numbers of peaks (RHSC) smaller than 350 peaks/0.5 mm² in the roughness curve, and therefore scratches generated by foreign matters were particularly inconspicuous as observed by visual inspection. Further, since the surface protection films of Examples 1 to 4 consisted of only the polymer resin and used no particles, they also showed superior optical transparency.

Further, in the surface protection film of Example 5, the surface profile of the uneven profile layer showed a maximum peak height (Rp) higher than 10.0 μm, and a number of peaks (RHSC) smaller than 350 peaks/0.5 mm² in the roughness curve, as in the surface protection films of Examples 1 and 2, and therefore scratches generated by foreign matters were particularly inconspicuous as observed by visual inspection. However, since the uneven profile thereof was formed with particles, it showed slightly inferior optical transparency compared with the surface protection films of Examples 1 to 4.

On the other hand, in the surface protection films of Comparative Examples 1 to 3, the surface profiles of the uneven profile layers showed maximum peak heights (Rp) lower than 6.0 μm, and numbers of peaks (RHSC) larger than 600 peaks/0.5 mm² in the roughness curves, and therefore scratches generated by foreign matters on the uneven surfaces of the surface protection films and the surfaces having been facing them were conspicuous as observed by visual inspection.

### 3. Production of Light-Diffusing Sheets

### Example 6

Components of a coating solution for light-diffusing layer of the following composition were mixed, and the mixture was stirred overnight, then applied to a support consisting of a polyethylene terephthalate film having a thickness of 50 μm (Lumirror T60, Toray Industries, Inc.) so as to obtain a dry thickness of 30 μm by the bar coating method, and dried to form a light-diffusing layer and thereby obtain a light-diffusing film of Example 6.

### <Coating Solution for Light-Diffusing Layer of Example 6>

| | |
|---|---|
| Acryl polyol (ACRYDIC A-807, Dainippon Ink | 162 parts |
| & Chemicals, Inc., solid content: 50%) | |
| Isocyanate type curing agent (Takenate D110N, | 32 parts |
| Mitsui Chemicals Polyurethane, Inc., | |
| solid content: 60%) | |
| Acrylic resin particles (polymethyl | 200 parts |
| methacrylate resin particles, Techpolymer MBX-20, | |
| Sekisui Plastics Co., Ltd., | |
| mean particle size: 20 μm) | |
| Butyl acetate | 215 parts |
| Methyl ethyl ketone | 215 parts |

### Example 7

A light-diffusing sheet of Example 7 was obtained in the same manner as that of Example 6, except that the addition amount of the acrylic resin particles in the coating solution for light-diffusing layer of Example 6 was changed to 210 parts, and the light-diffusing layer was designed to have a dry thickness of 35 μm.

### Example 8

A light-diffusing sheet of Example 8 was obtained in the same manner as that of Example 6, except that the coating solution for light-diffusing layer of Example 6 was changed to a coating solution for light-diffusing layer having the following composition, and the light-diffusing layer was designed to have a dry thickness of 20 μm.

### <Coating Solution for Light-Diffusing Layer of Example 8>

| | |
|---|---|
| Acryl polyol (ACRYDIC 49-394IM, Dainippon Ink | 210 parts |
| & Chemicals, Inc., solid content: 50%) | |
| Isocyanate type curing agent (Takenate D110N, | 41 parts |
| Mitsui Chemicals Polyurethane, Inc., | |
| solid content: 60%) | |
| Acrylic resin particles | 110 parts |
| (mean particle size: 10 μm) | |
| Silicone resin particles (Tospearl 130, | 7 parts |
| Toshiba Silicone Co., Ltd., | |
| mean particle size: 3 μm) | |
| Butyl acetate | 230 parts |
| Methyl ethyl ketone | 230 parts |

### Example 9

Components of a coating solution for light-diffusing layer of the following composition were mixed, and the mixture was stirred, then applied to a support consisting of a polyethylene terephthalate film having a thickness of 100 μm (Lumirror T60, Toray Industries, Inc.) so as to obtain a dry thickness of 27 μm by the bar coating method, and dried to form a light-diffusing layer and thereby obtain a light-diffusing film of Example 9.

### <Coating Solution for Light-Diffusing Layer of Example 9>

| | |
|---|---|
| Acryl polyol (ACRYDIC A-837, Dainippon Ink | 121 parts |
| & Chemicals, Inc., solid content: 50%) | |
| Isocyanate type curing agent (Takenate D110N, | 24 parts |
| Mitsui Chemicals Polyurethane, Inc., | |
| solid content: 60%) | |
| Acrylic resin particles | 121 parts |
| (mean particle size: 15 μm, | |
| coefficient of variation: 35%) | |
| Butyl acetate | 220 parts |
| Methyl ethyl ketone | 220 parts |

### Comparative Example 4

A light-diffusing sheet of Comparative Example 4 was obtained in the same manner as that of Example 6, except that the coating solution for light-diffusing layer of Example 6 was changed to a coating solution for light-diffusing layer having the following composition, and the light-diffusing layer was designed to have a dry thickness of 10 μm.

### <Coating Solution for Light-Diffusing Layer of Comparative Example 4>

| | |
|---|---|
| Acryl polyol (ACRYDIC A-807, Dainippon Ink | 162 parts |
| & Chemicals, Inc., solid content: 50%) | |
| Isocyanate type curing agent (Takenate D110N, | 32 parts |
| Mitsui Chemicals Polyurethane, Inc., | |
| solid content: 60%) | |
| Acrylic resin particles (MX-1000, Soken | 55 parts |
| Chemical & Engineering Co., Ltd., | |
| mean particle size: 10 μm) | |
| Silicone resin particles (Tospearl 130, | 15 parts |
| Toshiba Silicone Co., Ltd., | |
| mean particle size: 3 μm) | |
| Butyl acetate | 215 parts |
| Methyl ethyl ketone | 215 parts |

### Comparative Example 5

A light-diffusing sheet of Comparative Example 5 was obtained in the same manner as that of Comparative Example 4, except that the coating solution for light-diffusing layer of Comparative Example 4 was changed to a coating solution for light-diffusing layer having the following composition.

### <Coating Solution for Light-Diffusing Layer of Comparative Example 5>

| | |
|---|---|
| Acryl polyol (ACRYDIC 49-394IM, Dainippon Ink | 50 parts |
| & Chemicals, Inc., solid content: 50%) | |
| Acryl polyol (ACRYDIC A-807, Dainippon Ink | 40 parts |
| & Chemicals, Inc., solid content: 50%) | |
| Isocyanate type curing agent (Takenate D110N, | 20 parts |
| Mitsui Chemicals Polyurethane, Inc., | |
| solid content: 60%) | |
| Acrylic resin particles (Techpolymer MBX-8, | 100 parts |
| Sekisui Plastics Co., Ltd., | |
| mean particle size: 8 μm) | |
| Butyl acetate | 200 parts |
| Methyl ethyl ketone | 200 parts |

### Comparative Example 6

A light-diffusing sheet of Comparative Example 6 was obtained in the same manner as that of Comparative Example 4, except that the coating solution for light-diffusing layer of Comparative Example 4 was changed to a coating solution for light-diffusing layer having the following composition.

### <Coating Solution for Light-Diffusing Layer of Comparative Example 6>

| | |
|---|---|
| Acryl polyol (ACRYDIC A-807, Dainippon Ink | 100 parts |
| & Chemicals, Inc., solid content: 50%) | |
| Isocyanate type curing agent (Takenate D110N, | 20 parts |
| Mitsui Chemicals Polyurethane, Inc., | |
| solid content: 60%) | |
| Acrylic resin particles (Techpolymer MBX-8, | 100 parts |
| Sekisui Plastics Co., Ltd., | |
| mean particle size: 8 μm) | |
| Butyl acetate | 180 parts |
| Methyl ethyl ketone | 180 parts |

### 4. Evaluation

### (1) Three-Dimensional Profilometry of Uneven Surfaces of Light-Diffusing Sheets

Maximum peak heights (Rp) and numbers of peaks (RHSC) in roughness curves as determined by three-dimensional surface profilometry were measured for the uneven surfaces of the light-diffusing layers of the light-diffusing sheets obtained in Examples 6 to 9 and Comparative Examples 4 to 6. The results are shown in Table 2.

### (2) Light-Diffusing Property

The light-diffusing sheets of the examples and the comparative examples were each incorporated into a 13.3-inch edge-light type liquid crystal backlight unit (one straight lamp, thickness of light guide panel: 5 mm) so that the support thereof should face the light guide panel. As evaluation of light-diffusing property, ability of the light-diffusing sheets to vanish light diffusing pattern of the light guide panel was evaluated by visual inspection. The result that light diffusing pattern of the light guide panel could not be observed is indicated with the symbol “◯”, and the result that light diffusing pattern could be observed is indicated with the symbol “x”. The test results are shown in Table 2.

### (3) Anti-Scratch Property

Anti-scratch property was evaluated in the same manner as that of Example 1. The evaluation results are shown in Table 2.

TABLE 2

| | Maximum peak | Number of peaks | Light- | Anti- |
|---|---|---|---|---|
| | height (Rp) | (RHSC) | diffusing | scratch |
| | [μm] | [peaks/0.5 mm²] | property | property |
| Example 6 | 13.7 | 284 | ◯ | ⊚ |
| Example 7 | 10.9 | 344 | ◯ | ⊚ |
| Example 8 | 8.2 | 474 | ◯ | ◯ |
| Example 9 | 10.3 | 324 | ◯ | ⊚ |
| Comparative | 3.8 | 1076 | ◯ | X |
| Example 4 | | | | |
| Comparative | 4 | 650 | ◯ | X |
| Example 5 | | | | |
| Comparative | 5.3 | 816 | ◯ | X |
| Example 6 | | | | |

As shown in Table 2, the uneven surfaces of the light-diffusing layers in the light-diffusing sheets of Examples 6 to 9 showed maximum peak heights (Rp) higher than 6.0 μm, and numbers of peaks (RHSC) smaller than 600 peaks/0.5 mm² in the roughness curve determined by three-dimensional surface profilometry, and, therefore, scratches generated by foreign matters on the uneven surface of the light-diffusing sheets and the surfaces having been facing them were substantially inconspicuous as observed by visual inspection, and they also exhibited light-diffusing performance. In particular, in the light-diffusing sheets of Examples 6, 7 and 9, the uneven surfaces of the light-diffusing layers showed maximum peak heights (Rp) higher than 10.0 μm, and numbers of peaks (RHSC) smaller than 350 peaks/0.5 mm² in the roughness curves, and therefore scratches generated by foreign matters were particularly inconspicuous as observed by visual inspection.

On the other hand, the uneven surfaces of the light-diffusing layers in the light-diffusing sheets of Comparative Examples 4 to 6 showed maximum peak heights (Rp) lower than 6.0 μm and numbers of peaks (RHSC) larger than 600 peaks/0.5 mm² in the roughness curves determined by three-dimensional surface profilometry, and therefore scratches generated by foreign matters on the uneven surfaces of the light-diffusing sheets and the smooth surfaces of the light-diffusing sheets having been facing them were conspicuous as observed by visual inspection, although they exhibited light-diffusing performance.

1. An uneven surface film having an uneven profile on a surface of the film, wherein the uneven profile shows a maximum peak height (Rp) of 6.0 μm or higher and a number of peaks (RHSC) of 600 peaks/0.5 mm² or less in a roughness curve determined by three-dimensional surface profilometry.

2. The uneven surface film according to claim 1, which consists of a polymer resin.

3. The uneven surface film according to claim 1, which has an uneven profile layer comprising a polymer resin and microparticles.

4. The uneven surface film according to claim 1, wherein the uneven profile of the uneven surface film is formed by a shape transfer technique.

5. The uneven surface film according to claim 1, which is an anti-Newton ring film, a surface protection film, a non-glare sheet, a lens sheet, a light control sheet or a light-diffusing sheet.

6. A light-diffusing sheet comprising a light-diffusing layer having an uneven profile on a surface of the layer, wherein the uneven profile shows a maximum peak height (Rp) of 6.0 μm or higher and a number of peaks (RHSC) of 600 peaks/0.5 mm² or less in a roughness curve determined by three-dimensional surface profilometry.

7. The uneven surface film according to claim 2, which has an uneven profile layer comprising a polymer resin and microparticles.

8. The uneven surface film according to claim 2, wherein the uneven profile of the uneven surface film is formed by a shape transfer technique.

9. The uneven surface film according to claim 2, which is an anti-Newton ring film, a surface protection film, a non-glare sheet, a lens sheet, a light control sheet or a light-diffusing sheet.

10. The uneven surface film according to claim 3, which is an anti-Newton ring film, a surface protection film, a non-glare sheet, a lens sheet, a light control sheet or a light-diffusing sheet.

11. The uneven surface film according to claim 4, which is an anti-Newton ring film, a surface protection film, a non-glare sheet, a lens sheet, a light control sheet or a light-diffusing sheet.

12. The uneven surface film according to claim 7, which is an anti-Newton ring film, a surface protection film, a non-glare sheet, a lens sheet, a light control sheet or a light-diffusing sheet.

13. The uneven surface film according to claim 8, which is an anti-Newton ring film, a surface protection film, a non-glare sheet, a lens sheet, a light control sheet or a light-diffusing sheet.
